(19) United States
(12) Patent Application Publication
(10) Pub. No.: US 2015/0378661 A1
(43) Pub. Date: Dec. 31, 2015

(54) SYSTEM AND METHOD FOR DISPLAYING INTERNAL COMPONENTS OF PHYSICAL OBJECTS

(71) Applicant: Thomas Schick, Weinheim (DE)

(72) Inventor: Thomas Schick, Weinheim (DE)

(21) Appl. No.: 14/319,831

(22) Filed: Jun. 30, 2014

(51) Int. Cl. G06F 3/147; G06T 19/20; G06T 15/00; G06F 17/50

(52) U.S. Cl. CPC G06F 3/147; G06F 17/5009; G06T 19/20; G06T 15/005; G06F 2217/02; G06T 2219/2004; G06T 2215/16

(57) ABSTRACT

A system and a method for displaying an internal component of a physical object involve receiving an image captured by a camera. The image includes an external view of the object. A position of the camera relative to the object is calculated based on the captured image. Afterwards, an image is generated using the calculated relative position. The generated image shows the object from a perspective of the camera. When the camera's perspective overlaps with a specified internal component of the object, the generated image includes the internal component. The image is output for display.

### FIELD OF THE INVENTION

The present invention relates to a system and a method for displaying internal components of physical objects, using stored images of the internal components. The system and method also relate to displaying stored images that correspond to the perspective of a camera or similar device.

### BACKGROUND INFORMATION

The internal components of a physical object may be of interest, for example, during a design phase or when marketing the object to potential customers. Design engineers may create schematics including technical drawings of the object. The schematics may be difficult for people unused to working with technical drawings to understand. It may also be difficult to get a sense of the three-dimensionality of the object or its components from the schematics. Thus, it may be difficult to visualize how an internal component is organized in relation to the overall Object or in relation to other internal components.

### SUMMARY

Example embodiments of the present invention provide for a system and a method for displaying internal components of physical objects using stored images of the internal components.

Example embodiments provide for a system and a method for displaying an internal component of a physical object which involves receiving an image captured by, e.g., a camera or other image-recording device. The image includes an external view of the object. A position of the camera relative to the object is calculated based on the captured image. Then, an image is generated using the calculated relative position. The generated image shows the object from a perspective of, e.g., a camera. The generated image is output on a display, thus allowing a user to view an image of the object from the camera's perspective,

In an example embodiment, the camera and the display are located on a mobile computer device and the position of the mobile computer device in relation to the object is monitored in real-time to generate additional images corresponding to the perspective of the camera. In this way, for example, the display may be synchronized to camera movements.

In an example embodiment, the computer device detects an overlap between the camera's perspective and an internal component of an object. In response to detecting the overlap, an image is generated to show the object and the internal component simultaneously. Thus, internal components can be displayed to a user in the presence of the actual object, but without requiring the user to open the object (e.g., a machine, an apparatus, etc.). Internal components that are not ordinary accessible are thus made readily viewable.

### BRIEF DESCRIPTION OF THE DRAWINGS

FIG. 1 is a block diagram of a system for displaying internal components of physical objects, according to an example embodiment of the present invention.

FIGS. 2A to 2C show different views of a physical object, according to an example embodiment of the present invention.

FIGS. 3A to 3C show different views of a physical object displayed on a mobile computer device, according to an example embodiment of the present invention.

FIG. 4 is a flowchart of a method for displaying internal components of physical objects, according to an example embodiment of the present invention.

### DETAILED DESCRIPTION

Example embodiments of the present invention relate to the display of physical objects, including the simultaneous display of internal components and exteriors of the objects. The displaying may be performed on a mobile computer device equipped with a camera. Suitable mobile computers include, for example, tablets, laptops and smartphones.

Example embodiments of the present invention involve displaying an image of an internal component using image data stored in the form of computer-aided design (CAD) files. Other image formats may also be suitable for use with the example embodiments. The stored image data need not be limited to still images; in an example embodiment, the image data includes video.

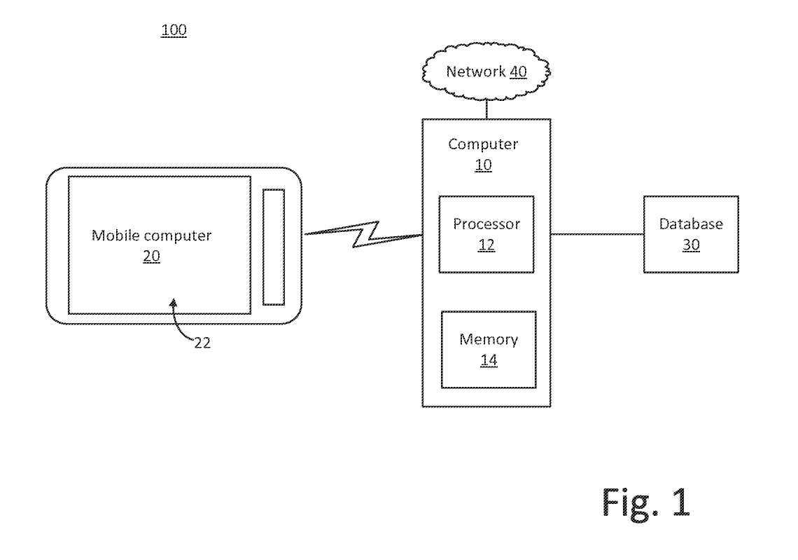

FIG. 1 shows a system 100 for displaying internal components of physical objects, according to an example embodiment of the present invention. The system 100 includes computer device 10, a mobile computer device 20 and a database 30. The computer 10 communicates with the computer 20 and the database 30, for example, using wireless and wired connections, respectively. In an example embodiment, the computer 10 may communicate with the computer 20 and the database 30 indirectly, via one or more intervening devices such as wireless routers, switches, relay servers, cellular networks, and other wired or wireless communication devices. Direct communication is also possible, for example, using Bluetooth.

The computer 10 includes a processor 12 and a memory 14. The memory 14 stores instructions and/or data in support of image processing and other functions performed by the computer 10. The functions include real-time monitoring of the movement, position relative to the object and/or orientation of the computer 20. Based on the monitoring, the computer 10 generates, using the processor 12, an image for display at the computer 20. The displayed image corresponds to the perspective of a camera on the computer 20. When the camera's perspective overlaps with the object, the displayed image is updated to include a corresponding view of the object's exterior. Similarly, when the camera's perspective overlaps with a specified internal component, the displayed image is updated to simultaneously show both the exterior and the internal component. Thus, the displayed image is synchronized to the movements of the computer 20.

In an example embodiment, the entire displayed image is an artificial representation of the object and replaces an actual image captured by the camera. In an alternative embodiment, the actual image is not replaced and is instead displayed together with additional images that show internal components of the object. The additional images may be superimposed onto the actual image.

The computer 20 can be a tablet, a laptop, a smartphone or any other camera-equipped computer device or image-recording device. The computer 20 includes a display 22 and a user interface, for example a keypad or a touchscreen interface. The camera may include a traditional complementary metal-oxide-semiconductor (CMOS) sensor array and is preferably mounted on a side of the computer 20 opposite the display 22 such that the display 22 faces a user when the camera faces the object. The display 22 may be a stationary display. Alternatively, the display 22 may be moveable in relation to a body of the computer 20, for example, tilted.

The computer 20 can, similar to the computer 10, include a processor and a memory. In an example embodiment, the processor of the computer 20 executes a software application for capturing and communicating images to and from the computer 10. Although certain processing steps are described herein as being performed at one or the other of the computers 10 and 20, it will be understood that the processing steps may be performed at a single computer, or performed at multiple computing devices (e.g., over one or more computing networks). In an alternative embodiment, all the processing may be performed at the computer 20.

The database 30 stores image data for one or more objects. The image data includes images of internal components of the objects. In an embodiment, the image data also shows the exterior of the object(s), for example, the image data may include a three-dimensional (3D) representation of an object, including the exterior of the object and its internal components. In an embodiment, the image data is stored in the form of CAD files, for example, Virtual Reality Modeling Language (VRML) files. The image data may, but need not, include color information. For example, the image data includes colorless wire-frame models of the objects. In an embodiment, the image data specifies not only the color, but also reflectivity, transparency, shading and other optical characteristics of the objects. In an example embodiment, the image data is stored and accessed using SAP AG's “3D Visual Enterprise” software, which converts CAD files into a format that can be viewed in a business environment without using a traditional CAD viewer.

In an embodiment, the image data includes video files, for example Moving Picture Experts Group (MPEG) files indexed using metadata that maps individual video frames to specific views of the object and/or its internal components. For example, a panoramic video may be used to show a pre-recorded object from different perspectives. Video can also show the object from the same or different perspectives over a period of time. As an alternative to recording an actual object, the video may be computer generated. For example, if the internal component is a car engine, the computer 10 or another processing device extrapolates, using still images of the engine in two piston positions (images obtained, for example, from a CAD model) or based on information describing how the pistons move, additional still images corresponding to intermediate piston positions, thus generating a video showing full movement of the pistons.

In an embodiment, the database 30 stores geometric data describing the objects and their components. Where the image data are stored as CAD files, the geometric data can be included in the image data, for example, as absolute dimensions (length, height, width, angle, radius, etc.) and/or relative dimensions (for example, distance between two points on an object or distance between two components). In an embodiment, the geometric data is stored separately from the image data, for example, as text files. The image data and the geometric data are transmitted to the computer 10 for use in generating images for display at the computer 20.

In an embodiment, in addition to the image data and the geometric data, the database 30 stores documents related to the objects. For example, the documents can relate to a business project involving the development, manufacture or sale of one or more objects. For example, the documents can be used in connection with enterprise resource planning (ERP) software or other legacy software. The ERP software, for example, can be executed at the computer 10 or another computer device. For example, objects are displayed in accordance with the example embodiments and in conjunction with ERP functionality. For example, the display occurs during product development to allow both technical and non-technical personnel to view the objects and their internal components, or, for example, the display occurs or can be used during a marketing presentation to allow potential customers to view the same.

The data previously described as being stored in the database 30 may, in an embodiment, be stored in a plurality of locations. For example, some image data or geometric data is stored on a remote database accessed via a network 40, which can be a private network, a controlled network, and/or a public network such as the Internet.

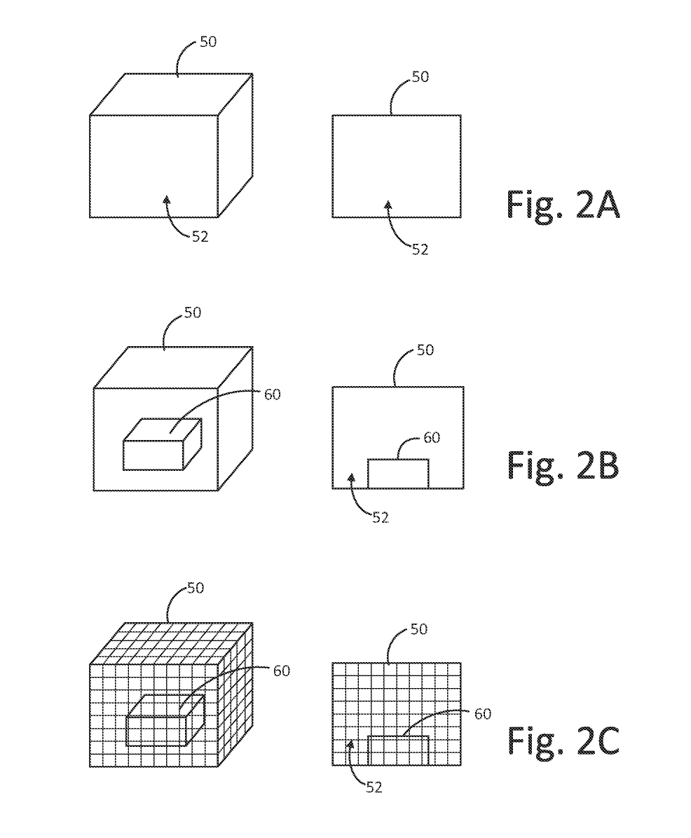

FIGS. 2A, 2B, and 2C show examples of how a display can be updated to simultaneously display an object together with an internal component, according to an example embodiment of the present invention. For illustration purposes, the Object is shown as a box 50 including an exterior surface 52, and the internal component is another box 60 nested within the outer box 50. In each of FIGS. 2A, 2B and 2C, an orthographic view is shown together with a corresponding front view facing the exterior surface 52. During actual display, the view will depend on how the computer 20 is positioned in relation to the object. For example, placing the computer 20 such that the camera (or image-recording device) is directly facing the exterior surface 52 may result in displaying the front view, which is two-dimensional (2D). From this position, tilting or moving the camera may cause a 3D effect similar to the orthographic view, in accordance with the corresponding shift in the camera's perspective.

In FIG. 2A, the outer box 50 is initially shown without the inner box 60. In this state, the outer box 50 can be displayed, for example, in color, colorless, opaque or semi-transparent. In FIG. 2B, the outer box 50 is shown simultaneously with the inner box 60. There are various ways in which the boxes 50, 60 can be simultaneously displayed. In an embodiment, both the outer box 50 and the inner box 60 are rendered transparent, in an embodiment, to make the inner box 60 more readily discernable, the optical characteristics of the inner box 60 are adjusted to create contrast between the boxes 50, 60. For example, the inner box 60 can be made less transparent, highlighted, shown in more vivid or a different color, etc. In FIG. 2C, the boxes are shown using wire-frames.

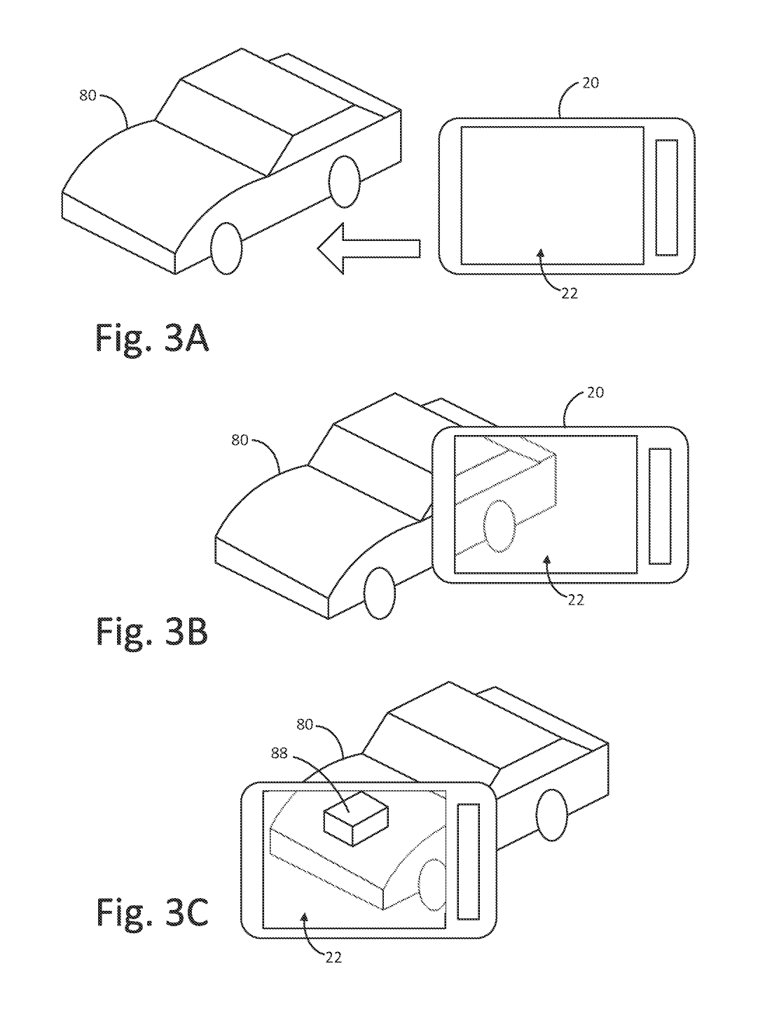

FIGS. 3A to 3C are a simplified representation of how the display 22 of the computer 20 can be updated to show different views of an object (a car 80) based on changes in camera perspective, according to an example embodiment of the present invention. In FIG. 3A, the computer 20 is positioned sufficiently far away from the car 80 that the camera's perspective does not overlap with any part of the car 80. In this state, the display 22 can show an actual image captured by the camera or a default image such as a predefined background image, or the display 22 can simply be turned off.

In FIG. 3B, the camera's perspective overlaps with part of the car 80, and the overlapping part is shown on the display 22. As mentioned previously, objects can be displayed using artificial images or actual captured images. If an artificial image is used, for example, the computer 10 monitors images captured by the computer 20 to determine when the camera's perspective begins to overlap with the car 80. In response to detecting the overlap, the computer 10 provides data (for example, the artificial images or data from which the artificial images can be generated at the computer 20) and/or instructions for displaying the overlapping part on the display 22, in accordance with the camera's perspective.

In an embodiment, overlap between the camera's perspective and an object or a specific part of the object such as an internal component) is detected using significant points located on a surface of the object. For example, in a car, significant points can correspond to the center locations of wheels, head lights or brake lights, or other points from which the boundaries of the car can be determined. In an embodiment, the significant points are predefined and can be included in the geometric data stored at the database 30. Predefining the significant points allows the computer 10 to calculate, based on information about the geometry of the object, how the camera is positioned in relation to the object. For example, an actual wheel diameter or an actual distance between two wheel centers can be compared to a wheel diameter/wheel distance in a captured image and analyzed, possibly together with the shape of the wheels in the captured image, to determine the camera's position. Thus, geometric information associated with the significant points and geometric information associated with corresponding points in the captured image can be used for determining the relative position of the camera. The relative position can be represented as a distance (for example, an offset value in an XYZ coordinate system) and/or an angle of rotation. Calculating the relative position of the camera can also involve using information about the optical characteristics of the camera. For example, the computer 10 can calculate the relative position using a focal length at which the images are captured, since focal length influences how three-dimensional points in space are projected onto two dimensions at the camera.

In an embodiment, reflective stickers or other markers are placed at the significant points to facilitate detection by making the significant points stand out in contrast to other parts of the object when captured by the camera. Such stickers have traditionally been used in the film industry for capturing moving objects. For example, stickers are used to capture facial expressions or body movements of human actors.

In an embodiment, in addition to significant points marking, other detection methods for determining the relative position of the camera are possible and would be known to one of ordinary skill in the art. In an embodiment, color or pattern recognition methods are used in combination with or as an alternative to significant points. For example, the detection may use techniques similar to facial recognition for auto-focusing in digital cameras, but applied to objects instead of people (or to people, if that is in the intended object). In an embodiment, the computer 20 includes at least one sensor that measures an orientation or a motion of the camera, for example, an accelerometer or a gyroscope. The sensor data and/or motion data derived from the sensor data can be transmitted to the computer 10 for monitoring the camera's motion and determining changes in relative position.

In an embodiment, after calculating the relative position, the computer 10 or other device generates an artificial image for display by, for example, transforming a 3D model of the object into a 2D image as a function of the relative position, so that the generated image corresponds to the camera's perspective. In FIG. 3B, for example, the portion of the car 80 shown on the display 22 can be an artificial image.

In FIG. 3C, the computer 20 is positioned such that the camera's perspective overlaps with an internal component 88 that has been specified (for example here, by the computer 10 or by a user of the computer 20) for viewing. The internal component 88 can be an engine block, a transmission, a wheel brake, or other component of interest. The internal component 88 is displayed simultaneously with other parts of the object 80, for example, in the manner previously described in connection with FIGS. 2B and 2C. In an embodiment where actual images are displayed, the computer 10 can generate an artificial image of the internal component 88 and output instructions for superimposing the image of the internal component 88 onto the actual image of the object 80, such that the location of the internal component 88 on the display matches the location of the internal component 88 in the actual object 80. For example, the computer 10 obtains a 3D model of the internal component 88 from the database 30 and generates a 2D image of the internal component 88, then output the 2D image together with instructions on where to position the 2D image by, for example, specifying an offset value based on a two-dimensional coordinate system of the display 22. In an example embodiment, the computer 10 obtains and/or generates video images of the internal component 88, for example, to show motion of an engine's pistons.

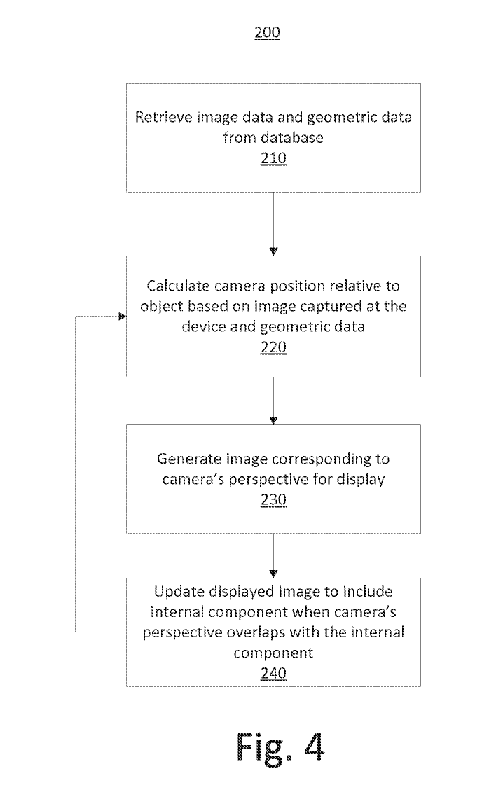

FIG. 4 is a flowchart of a method 200 for displaying internal components of physical objects, according to an example embodiment of the present invention. The method 200 can be performed using the system 100.

At step 210, image data and geometric data of an object are retrieved from the database. The retrieval can be performed by the computer 10 in response to a request from a user of the computer 20. The user can specify the object to be viewed, for example, by selecting from a list of objects available for viewing or inputting a model number or other object-identifying information. In an embodiment, the computer 10 can attempt to automatically match an object captured by the camera to an object stored at the database 30. The matching can be performed using significant points, color or pattern recognition, and/or other technique(s). Once the object or objects to be viewed have been identified to the computer 10, the corresponding image data and geometric data can be downloaded from the database 30.

In addition to specifying the object, the user can specify internal components to be viewed. For example, while a car has many internal components, only some of those components may be of interest to a particular user. In an embodiment, the user can specify only those components related to a specific vehicle system, such as the electrical system, the mechanical system or the hydraulics system, for viewing. In an embodiment, the computer 10 automatically determines which internal components are to be displayed based on an identity of the user. For example, the user's role within a business organization can determine whether the user has privileges for viewing certain components. Thus, components can be designated for public viewing or limited viewing, e.g., for viewing by select users, e.g., in a role-based or other authentication system.

At step 220, the computer 10 calculates the camera's position relative to an object, based on an image captured using the camera and further based on the geometric data.

At step 230, the computer 10 uses the relative position to generate an image corresponding to the camera's perspective. The generated image is then displayed at the display 22 of the computer 20 in place of an actual image captured by the camera. In an embodiment, if actual captured images are displayed, the computer 10 can wait until the camera's perspective overlaps with a specified internal component (step 240) before generating an image showing the specified component, together with instructions for superimposing the generated image onto an actual image.

At step 240, the computer updates the displayed image to include an internal component when the camera's perspective overlaps with the internal component. The method 200 can return to step 220 for continued monitoring and display.

In an embodiment, the computer 20 includes an interface for user input of text or other annotations such as hand drawings. The annotations are stored in association with the image data. For example, if the display 22 is a touchscreen, the user can tap a specific part of the displayed object to insert a text comment about the specified part. The comment is then saved, for example, by generating a screen capture of the displayed image together with the comment, or by transmitting the comment for storage at the database 30 as a new version of a document describing the object, for example, a new version of a CAD document. The saved comment can be made available for viewing by other users.

Embodiments of the present invention can include one or more processors, which can be implemented using any conventional processing circuit and device or combination thereof, e.g., a Central Processing Unit (CPU) of a Personal Computer (PC) or other workstation processor, to execute code provided, e.g., on a non-transitory hardware computer-readable medium including any conventional memory device, to perform any of the methods described herein, alone or in combination. The memory device can include any conventional permanent and/or temporary memory circuits or combination thereof, a non-exhaustive list of which includes Random Access Memory (RAM), Read Only Memory (ROM), Compact Disks (CD), Digital Versatile Disk (DVD), flash memory and magnetic tape.

Embodiments of the present invention include a non-transitory, hardware computer readable medium, e.g., some described herein, on which are stored instructions executable by a processor to perform any one or more of the methods/systems described herein.

Embodiments of the present invention include a method, e.g., of a hardware component or machine, of transmitting instructions executable by a processor to perform any one or more of the methods described herein.

The above description is intended to be illustrative, and not restrictive. Those skilled in the art can appreciate from the foregoing description that the present invention can be implemented in a variety of forms, and that the various embodiments can be implemented alone or in combination. Therefore, while the embodiments of the present invention have been described in connection with specific examples thereof, the true scope of the embodiments and/or methods of the present invention should not be so limited since other modifications will become apparent to the skilled practitioner upon a study of the drawings and specification. Features of the embodiments described herein can be used with and/or without each other in various combinations. Further, for example, steps illustrated in the flowcharts can be omitted and/or certain step sequences can be altered, and, in certain instances multiple illustrated steps can be simultaneously performed.

What is claimed is:

1. A computer implemented method for displaying an internal component of a physical object, comprising:
receiving an image captured by a camera, wherein the captured image includes an external view of the object;
calculating a position of the camera relative to the object based on the captured image;
at a processor of a computer device, generating an image using the calculated relative position, wherein the generated image shows an internal component of the object from a perspective of the camera; and
outputting the generated image display on a display device.

2. The method of claim 1, wherein the generated image shows the internal component and an exterior of the object simultaneously.

3. The method of claim 1, wherein the generated image is generated in response to detecting an overlap between the camera's perspective and the internal component.

4. The method of claim 1, wherein the generated image shows the internal component without showing an exterior of the object.

5. The method of claim 4, further comprising:
superimposing the generated image onto the captured image.

6. The method of claim 1, further comprising:
monitoring the relative position of the camera; and
updating the generated image based on changes in the relative position such that updated images correspond to the camera's perspective.

7. The method of claim 1, wherein the camera and the display device are located on a mobile computer device.

8. The method of claim 1, further comprising:
generating the generated image by transforming a three-dimensional model of the object in accordance with the camera's perspective.

9. The method of claim 1, further comprising:
calculating the relative position of the camera based on geometric information associated with predefined points on a surface of the object.

10. The method of claim 9, further comprising:
calculating the relative position of the camera based on geometric information associated with points in the captured image that correspond to the predefined points.

11. A system for displaying an internal component of a physical object, comprising:
a computer device configured to:
receive an image captured by a camera, wherein the captured image includes an external view of the object;
calculate a position of the camera relative to the object based on the captured image;
generate an image using the calculated relative position, wherein the generated image shows an internal component of the object from a perspective of the camera; and
output the generated image for a display on a display device.

12. The system of claim 11, wherein the generated image shows the internal component and an exterior of the object simultaneously.

13. The system of claim 11, wherein the computer device generates the generated image in response to detecting an overlap between the camera's perspective and the internal component.

14. The system of claim 11, wherein the generated image shows the internal component without showing an exterior of the object.

15. The method of claim 14, wherein the computer device is configured to superimpose the generated image onto the captured image.

16. The system of claim 11, wherein the computer device is configured to:
monitor the relative position of the camera; and
update the generated image based on changes in the relative position such that updated images correspond to the camera's perspective.

17. The system of claim 11, wherein the camera and the display device are located on a mobile computer device.

18. The system of claim 11, wherein the computer device is configured to generate the generated image by transforming a three-dimensional model of the object in accordance with the camera's perspective.

19. The system of claim 11, wherein the computer device is configured to calculate the relative position of the camera based on geometric information associated with predefined points on a surface of the object.

20. The method of claim 19, wherein the computer device is configured to calculate the relative position of the camera based on geometric information associated with points in the captured image that correspond to the predefined points.
